(19) United States
(12) Patent Application Publication
(10) Pub. No.: US 2025/0263567 A1
(43) Pub. Date: Aug. 21, 2025

(54) Ink Jet Ink Composition And Ink Jet Print Recording Method

(71) Applicant: SEIKO EPSON CORPORATION, Tokyo (JP)

(72) Inventors: Emi TAKEUCHI, Shiojiri (JP); Chigusa SATO, Matsumoto (JP)

(21) Appl. No.: 19/053,944

(22) Filed: Feb. 14, 2025

(30) Foreign Application Priority Data
Feb. 16, 2024 (JP) 2024-021803

(51) Int. Cl. C09D 11/30; B41M 5/00; B41M 7/00; C09D 11/107

(52) U.S. Cl. CPC C09D 11/30; B41M 5/0011; B41M 7/0081; C09D 11/107

(57) ABSTRACT

An ink jet ink composition includes a monomer and a resin. The monomer does not include an aromatic group-containing monomer, or includes an aromatic group-containing monomer in an amount of less than 35 mass % based on the total amount of the ink jet ink composition. The resin includes at least one of an acrylic resin (A) having hydroxy groups or carboxy groups and a resin (B) having one or more structural units selected from the group consisting of predetermined structural units.

The present application is based on, and claims priority from JP Application Serial Number 2024-021803, filed Feb. 16, 2024, the disclosure of which is hereby incorporated by reference herein in its entirety.

### BACKGROUND

### 1. Technical Field

The present disclosure relates to an ink jet ink composition and an ink jet print recording method.

### 2. Related Art

An ink jet recording method is capable of recording high-resolution images with a relatively simple apparatus, and is rapidly developing in various fields. Various studies have been made on the adhesion of a coating of an ink jet ink composition to a recording medium. For example, WO 2007/013368 discloses an active energy ray curable ink jet ink which contains polymerizable monomers comprising 95 to 99.99% by weight of a monofunctional monomer and 0.01 to 5% by weight of a polyfunctional monomer. When a cured coating having a thickness of 10 μm, formed using the active energy ray curable ink, is stretched at a temperature of 170° C. and a strain rate of 2/min, the ductility of the cured coating exceeds 120%. Thus, the active energy ray curable ink can provide a print which is excellent in the adhesion to a plastic substrate that requires bendability and stretchability, excellent in the processability, and is excellent in the abrasion resistance and friction resistance.

However, when the ink composition disclosed in the above-cited patent document is attached to a plastic recording medium by ink jet printing, the adhesion between the coating of the ink composition and the recording medium is still insufficient, and there is room for improvement. In addition, the ink composition has a problem with the odor of a coating of the ink composition.

### SUMMARY

According to an aspect of the present disclosure, an ink jet ink composition comprises a monomer and a resin, wherein the monomer does not comprise an aromatic group-containing monomer, or comprises an aromatic group-containing monomer in an amount of less than 35 mass % based on the total amount of the ink jet ink composition, and wherein the resin comprises at least one of an acrylic resin (A) having hydroxy groups or carboxy groups and a resin (B) having one or more structural units selected from the group consisting of structural units represented by the following formulas (1), (2), and (3):

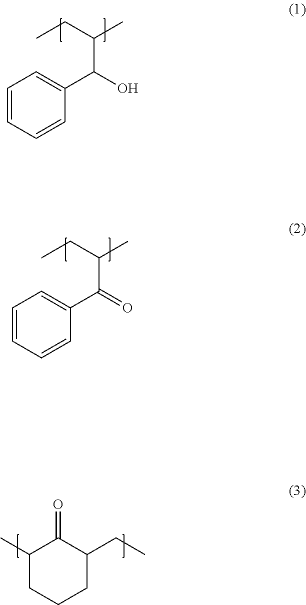

According to another aspect of the present disclosure, an ink jet print recording method comprises an ejection step of ejecting the above ink jet ink composition from an ink jet head and attaching the composition to a non-absorbent recording medium, and a curing step of curing the ink jet ink composition on the non-absorbent recording medium.

### BRIEF DESCRIPTION OF THE DRAWINGS

FIG. 1 is a table showing the results of Examples.

FIG. 2 is a table showing the results of Comparative Examples.

### DESCRIPTION OF EMBODIMENTS

Embodiments of the present disclosure (hereinafter referred to as “the present embodiments”) will now be described in detail. The embodiments described herein are for illustration of the present disclosure and are not to be construed as limiting thereof. It is to be understood that the scope of the present disclosure should be determined based on the claims, and that various changes and modifications can be made to the embodiments without departing from the spirit and scope of the present disclosure. As used herein, a numerical range such as “1 to 100” includes both the lower limit “1” and the upper limit “100”. The same holds true for other numerical ranges.

As used herein, “(meth)acryloyl” refers to at least one of acryloyl and the corresponding methacryloyl, “(meth)acrylate” refers to at least one of acrylate and the corresponding methacrylate, and “(meth)acrylic” refers to at least one of acrylic and the corresponding methacrylic.

### 1. Ink Jet Ink Composition

The ink jet ink composition according to the present embodiments (hereinafter also referred to simply as “the ink composition”) comprises a monomer and a resin. The monomer does not comprise an aromatic group-containing monomer, or comprises an aromatic group-containing monomer in an amount of less than 35 mass % based on the total amount of the ink composition. The resin comprises at least one of an acrylic resin (A) having hydroxy groups or carboxy groups and a resin (B) having one or more structural units selected from the group consisting of structural units represented by the following formulas (1), (2), and (3):

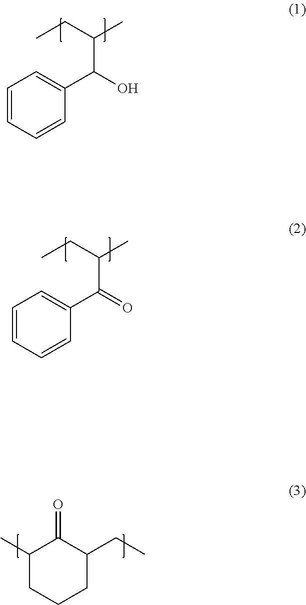

As the content of the aromatic group-containing monomer in the ink composition increases, the odor of a coating obtained using the ink composition tends to become more pronounced. On the other hand, as the content of the aromatic group-containing monomer in the ink composition decreases, the adhesion of the ink composition to a recording medium decreases.

In the present embodiments, the use of the particular acrylic resin (A) or resin (B) can achieve an improvement in the adhesion of the ink composition to a recording medium while achieving reduced odor of a coating by reducing the content of the aromatic group-containing monomer. The improvement in the adhesion of the ink composition to a recording medium, achieved by the use of the particular resin, may be due to the action of polar groups at the interface between the ink composition and the recording medium, though not being bound to such mechanism.

The ink composition according to the present embodiments is an ink composition which is to be ejected from an ink jet head in an ink jet process, and may be a radiation-curable ink jet ink composition which is cured by exposure to radiation. A radiation-curable ink composition will be described hereinbelow as an embodiment of the ink composition. It is to be noted that the composition according to the present embodiments may be a composition other than an ink composition, for example a composition for use in 3D additive manufacturing.

The radiation-curable ink composition is cured by exposing it to radiation. Examples of the radiation include ultraviolet light, electron beam, infrared light, visible light, and X-rays. Ultraviolet light is preferred as radiation because UV radiation sources are readily available and widely used, and materials suitable for curing by ultraviolet radiation are readily available and widely used.

### 1.1. Resin

The resin of the present embodiments comprises at least one of an acrylic resin (A) having hydroxy groups or carboxy groups and a resin (B) having one or more structural units selected from the group consisting of structural units represented by the following formulas (1), (2), and (3):

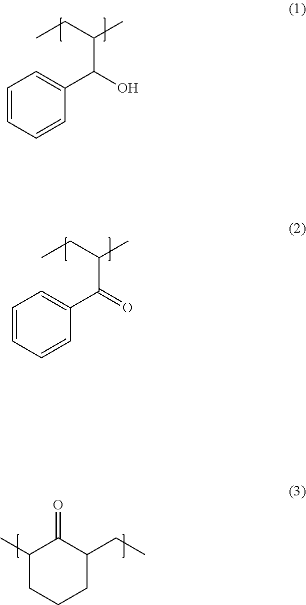

The type of the resin is not particularly limited as long as it comprises at least one of the acrylic resin (A) and the resin (B). The resin may comprise an additional resin(s) besides the acrylic resin (A) and the resin (B). The resin may be of a single type or of a combination of two or more types. The use of such a resin makes it possible to improve the adhesion that is required for the ink jet ink composition when it is attached to a recording medium. In particular, the adhesion to a non-absorbent recording medium can be improved.

The weight average molecular weight (Mw) of the resin is preferably 20000 or less, 15000 or less, 10000 or less, or 5000 or less. The weight average molecular weight (Mw) of the resin is preferably 1000 or more, 2000 or more, 3000 or more, or 4000 or more. When the weight average molecular weight of the resin is 20000 or less, the viscosity of the ink composition tends to be low; the ink composition tends to exhibit excellent ejectability when it is ejected. When the weight average molecular weight of the resin is within the above ranges, the ink composition tends to have excellent adhesion to a recording medium. The weight average molecular weight (Mw) of the resin can be measured using gel permeation chromatography (GPC). For example, it can be determined using tetrahydrofuran as an eluent and polystyrene as a standard substance.

The content of the resin is preferably 10 mass % or less, 8 mass % or less, or 6 mass % or less based on the total amount of the ink composition. The resin content is preferably 1 mass % or more, 2 mass % or more, or 3 mass % or more based on the total amount of the ink composition. When the resin content is 10 mass % or less, the viscosity of the ink composition can be made low. Therefore, the ejectability of the ink composition tends to be further improved. When the resin content is 1 mass % or more, the adhesion between the ink composition and a recording medium tends to be further improved.

### 1.1.1. Acrylic Resin (A)

The acrylic resin (A) of the present embodiments is not particularly limited as long as it is an acrylic resin having at least one hydroxy group or carboxy group in one molecule. The acrylic resin (A) may also have other functional group(s).

Acrylic resin is a general term for polymers obtained by polymerizing at least an acrylic monomer, such as (meth)acrylic acid or a (meth)acrylic acid ester, as one component. Examples include a homopolymer obtained from an acrylic monomer, and a copolymer of an acrylic monomer and other monomer(s). An acrylic-vinyl resin, which is a copolymer of an acrylic monomer and a vinyl monomer, is an example of the copolymer of an acrylic monomer and other monomer(s).

The glass transition temperature (Tg) of the acrylic resin (A) is preferably −70 to 140° C., −65 to 110° C., or −60 to 80° C. When the glass transition temperature (Tg) of the acrylic resin (A) is within the above ranges, the adhesion of the ink composition to a recording medium tends to be further improved.

When the acrylic resin (A) has hydroxy groups, the hydroxyl value (OHV) of the acrylic resin (A) is preferably 1 to 120 KOHmg/g, 5 to 90 KOHmg/g, 10 to 60 KOHmg/g, or 15 to 30 KOHmg/g. When the hydroxyl value (OHV) is within the above ranges, the adhesion of the ink composition to a recording medium tends to be further improved.

When the acrylic resin (A) has carboxy groups, the acid value (AV) of the acrylic resin (A) is preferably 30 to 250 KOHmg/g, 40 to 200 KOHmg/g, 50 to 150 KOHmg/g, or 60 to 100 KOHmg/g. When the acid value (AV) is within the above ranges, the adhesion of the ink composition to a recording medium tends to be further improved.

The acid value and the hydroxyl value can be measured using potentiometric titration. For example, the measurement can be performed based on “JIS K 0070 Test methods for acid value, saponification value, ester value, iodine value, hydroxyl value and unsaponifiable matter of chemical products”. An example of a potentiometric titrator is automatic potentiometric titrator AT610 (manufactured by Kyoto Electronics Manufacturing Co., Ltd.).

Examples of known commercially available acrylic resins having hydroxy groups include ARUFON (registered trademark) UH-2000 series (UH-2000, UH-2041, UH-2170, UH-2190) manufactured by Toagosei Co., Ltd.

Examples of known commercially available acrylic resins having carboxy groups include ARUFON (registered trademark) UC-3000 series (UC-3000, UC-3080, UC-3510) and UF-5000 series (UF-5080), manufactured by Toagosei Co., Ltd.

### 1.1.2. Resin (B)

As long as the resin (B) has one or more structural units selected from the group consisting of structural units represented by the following formulas (1), (2), and (3), it may have an additional structural unit(s) besides the one or more structural units:

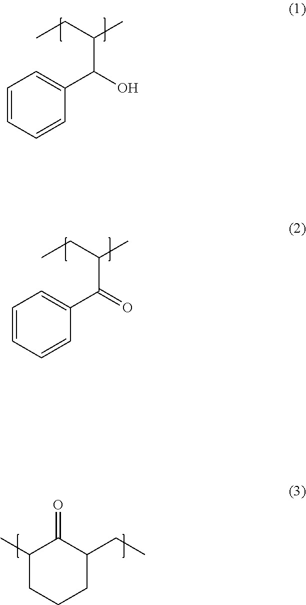

Examples of such resin (B) include, and are not limited to, a polyol resin having the structural unit represented by formula (1), and a ketone-aldehyde condensation resin having the structural unit represented by formula (2) or (3).

The glass transition temperature (Tg) of the resin (B) is preferably −70 to 140° C., −30 to 120° C., 0 to 110° C., or 40 to 100° C. When the glass transition temperature (Tg) of the resin (B) is within the above ranges, the adhesion of the ink composition to a recording medium tends to be further improved.

The hydroxyl value (OHV) of the resin (B) having the structural unit represented by formula (1) is preferably 400 KOHmg/g or less, 350 KOHmg/g or less, 300 KOHmg/g or less, 250 KOHmg/g or less, 200 KOHmg/g or less, 150 KOHmg/g or less, 100 KOHmg/g or less, or 50 KOHmg/g or less. The hydroxyl value (OHV) of the resin (B) having the structural unit represented by formula (1) is preferably 1 KOHmg/g or more, 5 KOHmg/g or more, 10 KOHmg/g or more, 25 KOHmg/g or more, 50 KOHmg/g or more, or 100 KOHmg/g or more.

Examples of known commercially available resins (B) include TEGO (registered trademark) Variplus SK, Variplus AP and Variplus CA, manufactured by Evonik Industries.

### 1.2. Monomer

The monomer of the present embodiments is not particularly limited, and may be a monofunctional monomer having one polymerizable functional group, or a polyfunctional monomer having a plurality of polymerizable functional groups. The monomer of the present embodiments may be of a single type or of a combination of two or more types.

Examples of monomers usable in the ink composition of the present embodiments include a saturated aliphatic group-containing monomer, a nitrogen-containing monomer, an oxygen-containing monomer, and a hydroxy group-containing monomer. While the ink composition may contain an aromatic group-containing monomer, it preferably does not contain an aromatic group-containing monomer. Instead of or in addition to the above monomers, the ink composition may contain other monomer(s) as necessary. There is no particular limitation on the other monomer(s); for example, it is possible to use a conventionally-known monomer having a polymerizable functional group(s), in particular a polymerizable functional group(s) having a carbon-carbon unsaturated double bond.

The content of the monofunctional monomer is preferably 35 to 90 mass % or 40 to 90 mass %, and particularly preferably 70 to 90 mass % based on the total monomer amount. When the content of the monofunctional monomer is 35 mass % or more based on the total monomer amount, the ink composition tends to have excellent curability. When the content of the monofunctional monomer is 90 mass % or less, the odor of a coating of the ink composition tends to be further reduced.

The content of the polyfunctional monomer is preferably 10 to 65 mass %, 10 to 55 mass %, or 10 to 30 mass % based on the total monomer amount. When the content of the polyfunctional monomer based on the total monomer amount is within the above ranges, the adhesion of a coating to a recording medium tends to be improved.

### 1.2.1. Aromatic Group-Containing Monomer

The monomer of the present embodiments preferably does not comprise an aromatic group-containing monomer. When the present monomer comprises an aromatic group-containing monomer, the content of the aromatic group-containing monomer is less than 35 mass % based on the total amount of the ink composition. The content is preferably low. No particular limitation is placed on the aromatic group-containing monomer as long as it has an aromatic group and one or more polymerizable functional groups. Examples of the aromatic group-containing monomer include an aromatic group-containing monofunctional monomer having one polymerizable functional group, and an aromatic group-containing polyfunctional monomer having a plurality of polymerizable functional groups. The aromatic group-containing monomer may be of a single type or of a combination of two or more types.

Examples of the aromatic group-containing monomer include, and are not limited to, phenoxyethyl (meth)acrylate, benzyl (meth)acrylate, alkoxylated 2-phenoxyethyl (meth)acrylate, ethoxylated nonylphenyl (meth)acrylate, alkoxylated nonylphenyl (meth)acrylate, p-cumylphenol EO-modified (meth)acrylate, and 2-hydroxy-3-phenoxypropyl (meth)acrylate.

When the present monomer comprises an aromatic group-containing monomer, the content of the aromatic group-containing monomer is less than 35 mass %, preferably 20 mass % or less, 15 mass % or less, 10 mass % or less, or 5 mass % or less based on the total amount of the ink composition. While the lower limit of the content of the aromatic group-containing monomer is not particularly limited, the content is preferably as low as possible and may be zero (0 mass %). When the content of the aromatic group-containing monomer is less than 35 mass %, the odor of a cured product of the ink composition tends to be reduced. The odor can be further reduced when the present monomer does not comprise an aromatic group-containing monomer.

### 1.2.2. Nitrogen-Containing Monomer

The nitrogen-containing monomer is not particularly limited, and may be a nitrogen-containing monofunctional monomer having one polymerizable functional group, or a nitrogen-containing polyfunctional monomer having a plurality of polymerizable functional groups, preferably a nitrogen-containing monofunctional monomer, and more preferably a nitrogen-containing monofunctional monomer having a nitrogen-containing heterocyclic structure. The nitrogen-containing heterocyclic structure may further contain an oxygen atom in the heterocyclic structure. The nitrogen-containing monomer may be of a single type or of a combination of two or more types.

Examples of the nitrogen-containing monomer include nitrogen-containing vinyl monomers such as vinylmethyloxazolidinone (VMOX), N-vinylcaprolactam, N-vinylformamide, N-vinylcarbazole, N-vinylacetamide, and N-vinylpyrrolidone; nitrogen-containing acrylate monomers such as acryloylmorpholine; and nitrogen-containing acrylamide monomers such as (meth)acrylamide, N-hydroxymethyl(meth)acrylamide, diacetone acrylamide, N,N-dimethyl(meth)acrylamide, and dimethylaminoethyl acrylate benzyl chloride quaternary salt.

Among them, the nitrogen-containing monomer preferably comprises a nitrogen-containing vinyl monomer or a nitrogen-containing acrylate monomer, more preferably a monomer having a nitrogen-containing heterocyclic structure, such as vinylmethyloxazolidinone (VMOX), N-vinylcaprolactam, N-vinylcarbazole, N-vinylpyrrolidone, or acryloylmorpholine, in particular a nitrogen-containing vinyl monomer having an oxazolidine group, and particularly preferably comprises vinylmethyloxazolidinone (VMOX).

The use of such a nitrogen-containing monomer tends to further improve the curability of a coating of the ink composition. The use of a nitrogen-containing monofunctional vinyl monomers having a nitrogen-containing heterocyclic structure, such as vinylmethyloxazolidinone (VMOX), tends to further improve the curability of a coating.

The content of the nitrogen-containing monomer is preferably 5 to 50 mass %, 10 to 40 mass %, 15 to 35 mass %, or 20 to 30 mass % based on the total amount of the ink composition. When the content of the nitrogen-containing monomer is within the above ranges, the adhesion and curability of a coating tend to be further improved.

### 1.2.3. Hydroxy Group-Containing Monomer

The hydroxy group-containing monomer is not particularly limited, and may be a hydroxy group-containing monofunctional monomer having one polymerizable functional group, or a hydroxy group-containing polyfunctional monomer having a plurality of polymerizable functional groups, preferably a hydroxy group-containing monofunctional monomer. The hydroxy group-containing monomer may be of a single type or of a combination of two or more types.

Examples of the hydroxy group-containing monomer include, and are not limited to, hydroxyalkyl (meth)acrylates such as 2-hydroxyethyl (meth)acrylate, 2-hydroxypropyl (meth)acrylate, 3-hydroxypropyl (meth)acrylate, 3-hydroxybutyl (meth)acrylate, and 4-hydroxybutyl (meth)acrylate.

Among them, 4-hydroxybutyl (meth)acrylate is preferred, and 4-hydroxybutyl acrylate (4-HBA) is particularly preferred. The use of such a hydroxy group-containing monomer tends to improve the adhesion and curability of a coating of the ink composition.

The content of the hydroxy group-containing monomer is preferably 3 to 17 mass %, 5 to 15 mass %, or 7 to 13 mass % based on the total amount of the ink composition. When the content of the hydroxy group-containing monomer is within the above ranges, the adhesion and curability of a coating tend to be further improved.

### 1.2.4. Vinyl Ether Group-Containing (Meth)Acrylate

The vinyl ether group-containing (meth)acrylate is not particularly limited and may be, for example, a compound represented by the following formula (4):

CH₂═CR¹—COOR²—O—CH═CH—R³ (4)

where R¹ is a hydrogen atom or a methyl group, R² is a divalent organic residue having 2 to 20 carbon atoms, and R³ is a hydrogen atom or a monovalent organic residue having 1 to 11 carbon atoms. The inclusion of such a vinyl ether group-containing (meth)acrylate tends to reduce the viscosity of the composition, thereby further improving the ejection stability. In addition, the curability of the composition is further improved. The improvement in the curability enables a faster recording speed.

Examples of the divalent organic residue having 2 to 20 carbon atoms, represented by R² in the above formula (4), include a linear, branched or cyclic alkylene group, which may be substituted, having 2 to 20 carbon atoms, an alkylene group, which may be substituted, having 2 to 20 carbon atoms and having an oxygen atom(s) in an ether bond and/or an ester bond in the structure, and a divalent aromatic group, which may be substituted, having 6 to 11 carbon atoms. In particular, an alkylene group having 2 to 6 carbon atoms, such as an ethylene group, an n-propylene group, an isopropylene group, or a butylene group, and an alkylene group having 2 to 9 carbon atoms and having an oxygen atom in an ether bond in the structure, such as an oxyethylene group, an oxy n-propylene group, an oxyisopropylene group, or an oxybutylene group, are preferred. A compound having a glycol ether chain in which R² is an alkylene group having 2 to 9 carbon atoms and having an oxygen atom in an ether bond in the structure, such as an oxyethylene group, an oxy n-propylene group, an oxyisopropylene group, or an oxybutylene group, is more preferred from the viewpoint of being capable of further reducing the viscosity of the composition and further improving the curability of the composition.

The monovalent organic residue having 1 to 11 carbon atoms, represented by R³ in the above formula (4), is preferably a linear, branched or cyclic alkyl group, which may be substituted, having 1 to 10 carbon atoms, or an aromatic group, which may be substituted, having 6 to 11 carbon atoms. In particular, an alkyl group having 1 to 2 carbon atoms, namely a methyl group or an ethyl group, and an aromatic group having 6 to 8 carbon atoms, such as a phenyl group or a benzyl group, are preferably used.

In each of the above-described organic residues which may be substituted, the substituent can be classified either as a group which contains a carbon atom(s) or as a group which contains no carbon atom. In the case of a group which contains a carbon atom(s), the carbon atom(s) is counted in the number of carbon atoms of the organic residue. Examples of groups which contain a carbon atom(s) include, and are not limited to, a carboxy group and an alkoxy group. Examples of groups which contain no carbon atom include, and are not limited to, a hydroxy group and a halo group.

Specific examples of the compound of formula (4) include, and are not limited to, 2-vinyloxyethyl (meth)acrylate, 3-vinyloxypropyl (meth)acrylate, 1-methyl-2-vinyloxyethyl (meth)acrylate, 2-vinyloxypropyl (meth)acrylate, 4-vinyloxybutyl (meth)acrylate, 1-methyl-3-vinyloxypropyl (meth)acrylate, 1-vinyloxymethylpropyl (meth)acrylate, 2-methyl-3-vinyloxypropyl (meth)acrylate, 1,1-dimethyl-2-vinyloxyethyl (meth)acrylate, 3-vinyloxybutyl (meth)acrylate, 1-methyl-2-vinyloxypropyl (meth)acrylate, 2-vinyloxybutyl (meth)acrylate, 4-vinyloxycyclohexyl (meth)acrylate, 6-vinyloxyhethyl (meth)acrylate, 4-vinyloxymethylcyclohexylmethyl (meth)acrylate, 3-vinyloxymethylcyclohexylmethyl (meth)acrylate, 2-vinyloxymethylcyclohexylmethyl (meth)acrylate, p-vinyloxymethylphenylmethyl (meth)acrylate, m-vinyloxymethylphenylmethyl (meth)acrylate, o-vinyloxymethylphenylmethyl (meth)acrylate, 2-(2-vinyloxyethoxy)ethyl (meth)acrylate, 2-(2-vinyloxyethoxy)ethyl acrylate, 2-(vinyloxyisopropoxy)ethyl (meth)acrylate, 2-(vinyloxyethoxy)propyl (meth)acrylate, 2-(vinyloxyethoxy)isopropyl (meth)acrylate, 2-(vinyloxyisopropoxy)propyl (meth)acrylate, 2-(vinyloxyisopropoxy)isopropyl (meth)acrylate, 2-(vinyloxyethoxyethoxy)ethyl (meth)acrylic acid, 2-(vinyloxyethoxyisopropoxy)ethyl (meth)acrylate, 2-(vinyloxyisopropoxyethoxy)ethyl (meth)acrylate, 2-(vinyloxyisopropoxyisopropoxy)ethyl (meth)acrylate, 2-(vinyloxyethoxyethoxy)propyl (meth)acrylate, 2-(vinyloxyethoxyisopropoxy)propyl (meth)acrylate, 2-(vinyloxyisopropoxyethoxy)propyl (meth)acrylate, 2-(vinyloxyisopropoxyisopropoxy)propyl (meth)acrylate, 2-(vinyloxyethoxyethoxy)isopropyl (meth)acrylate, 2-(vinyloxyethoxyisopropoxy)isopropyl (meth)acrylate, 2-(vinyloxyisopropoxyethoxy)isopropyl (meth)acrylate, 2-(vinyloxyisopropoxyisopropoxy)isopropyl (meth)acrylate, 2-(vinyloxyethoxyethoxyethoxy)ethyl (meth)acrylate, 2-(vinyloxyethoxyethoxyethoxyethoxy)ethyl (meth)acrylate, 2-(isopropenoxyethoxy)ethyl (meth)acrylate, 2-(isopropenoxyethoxyethoxy)ethyl (meth)acrylate, 2-(isopropenoxyethoxyethoxy)ethyl (meth)acrylate, 2-(isopropenoxyethoxyethoxyethoxy)ethyl (meth)acrylate, 2-(isopropenoxyethoxyethoxyethoxyethoxy)ethyl (meth)acrylate, polyethylene glycol monovinyl ether (meth)acrylate, and polypropylene glycol monovinyl ether (meth)acrylate. Among these compounds, 2-(2-vinyloxyethoxy)ethyl acrylate is particularly preferred in that it can easily balance the curability and viscosity of the composition. 2-(2-vinyloxyethoxy)ethyl acrylate will also be referred to herein as VEEA.

The content of the vinyl ether group-containing (meth)acrylate is preferably 0.1 to 40 mass %, 0.1 to 30 mass %, 1 to 25 mass %, 1 to 20 mass %, or 2 to 15 mass % based on the total amount of the ink composition. When the content of the vinyl ether group-containing (meth)acrylate based on the total amount of the ink composition is within the above ranges, the viscosity of the composition tends to be reduced and the ejection stability tends to be further improved.

### 1.2.5. Other Monofunctional Monomers

The ink composition of the present embodiments may contain other monofunctional monomer(s) such as an aliphatic group-containing monofunctional monomer or an oxygen-containing monofunctional monomer.

### 1.2.5.1. Aliphatic Group-Containing Monofunctional Monomer

Examples of the aliphatic group-containing monofunctional monomer include, and are not limited to, an alicyclic group-containing monofunctional monomer such as isobornyl (meth)acrylate (IBXA), tert-butyl cyclohexanol acrylate (TBCHA), or 1,4-dioxaspiro[4,5]dec-2-ylmethyl 2-(meth)acrylate; a linear or branched aliphatic group-containing monofunctional monomer such as isoamyl (meth)acrylate, stearyl (meth)acrylate, lauryl (meth)acrylate, octyl (meth)acrylate, decyl (meth)acrylate, isodecyl (meth)acrylate, isomyristyl (meth)acrylate, isostearyl (meth)acrylate, 2-hydroxybutyl (meth)acrylate, butoxyethyl (meth)acrylate, or tetrahydrofurfuryl (meth)acrylate; and a lactone-modified flexible (meth)acrylate. Among them, an alicyclic group-containing monofunctional monomer is preferred. The use of an aliphatic group-containing monofunctional monomer tends to further improve the curability of the composition.

The content of the aliphatic group-containing monofunctional monomer is preferably 4 to 30 mass %, 6 to 20 mass %, or 8 to 15 mass % based on the total amount of the ink composition. When the content of the aliphatic group-containing monofunctional monomer is within the above ranges, the adhesion and curability of a coating tend to be further improved.

### 1.2.5.2. Oxygen-Containing Monofunctional Monomer

The oxygen-containing monofunctional monomer is not particularly limited and may be, for example, a monomer having a cyclic structure containing oxygen. The monomer having a cyclic structure containing oxygen may be an oxygen-containing monomer comprising a cyclic ether structure. Examples of the oxygen-containing monomer comprising a cyclic ether structure include cyclic trimethylolpropane formal acrylate (CTFA), cyclic trimethylolpropane formal methacrylate, tetrahydrofurfuryl acrylate (THFA), and (2-methyl-2-ethyl-1,3-dioxolan-4-yl)methyl acrylate (MEDOL-10). Among them, cyclic trimethylolpropane formal acrylate (CTFA) and (2-methyl-2-ethyl-1,3-dioxolan-4-yl)methyl acrylate (MEDOL-10) are preferred. The use of such an oxygen-containing monofunctional monomer comprising a cyclic ether structure tends to be capable of improving the adhesion and curability of a coating.

The content of the oxygen-containing monofunctional monomer is preferably 10 to 50 mass %, 15 to 45 mass %, 20 to 40 mass %, or 25 to 35 mass % based on the total amount of the ink composition. When the content of the oxygen-containing monofunctional monomer is within the above ranges, the adhesion and curability of a coating tend to be further improved.

### 1.2.6. Other Polyfunctional Monomers

The ink composition of the present embodiments may contain other polyfunctional monomer(s) besides the above-described monomers. A polyfunctional (meth)acrylate is a non-limiting example of the other polyfunctional monomer(s).

### 1.2.6.1. Polyfunctional (Meth)Acrylate

Examples of the polyfunctional (meth)acrylate include, and are not limited to, bifunctional (meth)acrylates such as dipropylene glycol diacrylate (DPGDA), diethylene glycol di(meth)acrylate, triethylene glycol di(meth)acrylate, tetraethylene glycol di(meth)acrylate, polyethylene glycol di(meth)acrylate, dipropylene glycol dimethacrylate, tripropylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethylol-tricyclodecane di(meth)acrylate, EO (ethylene oxide) adduct di(meth)acrylate of bisphenol A, PO (propylene oxide) adduct di(meth)acrylate of bisphenol A, hydroxypivalic acid neopentyl glycol di(meth)acrylate, and polytetramethylene glycol di(meth)acrylate; and polyfunctional (meth)acrylates having three or more functional groups such as trimethylolpropane tri(meth)acrylate, EO-modified trimethylolpropane tri(meth)acrylate, pentaerythritol tri(meth)acrylate, pentaerythritol tetra(meth)acrylate, dipentaerythritol hexa(meth)acrylate (ADPH), ditrimethylolpropane tetra(meth)acrylate, glycerin propoxy tri(meth)acrylate, caprolactone-modified trimethylolpropane tri(meth)acrylate, pentaerythritol ethoxy tetra(meth)acrylate, and caprolactam-modified dipentaerythritol hexa(meth)acrylate (ADPH). In particular, among the bifunctional (meth)acrylates, a polyhydric propylene glycol diacrylate is preferred, and dipropylene glycol diacrylate (DPGDA) and tripropylene glycol di(meth)acrylate (TPGDA) are more preferred because of excellent curability and adhesion.

The content of the polyfunctional (meth)acrylate is preferably 1 to 50 mass %, 2.5 to 40 mass %, 5 to 35 mass %, or 7.5 to 30 mass % based on the total amount of the ink composition. When the content of the polyfunctional (meth)acrylate based on the total amount of the composition is within the above ranges, the adhesion of a coating tends to be improved.

### 1.3. Other Components

The ink composition according to the present embodiments may further contain additives such as an oligomer, a dispersant, a polymerization inhibitor, and a slip agent as necessary.

### 1.3.1. Oligomer

The ink composition according to the present embodiments may contain an oligomer. As used herein, an oligomer refers to a multimer comprising a polymerizable compound as a constituent and having one or more functional groups. The polymerizable compound is not limited to the above-described ones. In addition to the above definition, a monomer is herein defined as a polymerizable compound having a molecular weight of 1000 or less, and an oligomer as a polymerizable compound having a molecular weight of more than 1000.

Examples of the oligomer include, and are not limited to, a urethane acrylate oligomer having a urethane repeating structure, a polyester acrylate oligomer having an ester repeating structure, and an epoxy acrylate oligomer whose repeating structure is derived from an epoxy group-containing polymerizable compound.

The ink composition preferably does not contain an aromatic group-containing oligomer. When the ink composition contains an aromatic group-containing oligomer, its content is preferably 20 mass % or less, or 10 mass % or less based on the total amount of the ink composition. When the content is within the above ranges, the odor of a coating tends to be reduced.

### 1.3.2. Photopolymerization Initiator

The ink composition according to the present embodiments may further contain a photopolymerization initiator. The photopolymerization initiator may be of a single type or of a combination of two or more types.

The photopolymerization initiator is not particularly limited as long as it generates an active species when exposed to radiation. Examples of the photopolymerization initiator include known photopolymerization initiators such as an acylphosphine oxide photopolymerization initiator, an alkylphenone photopolymerization initiator, a titanocene photopolymerization initiator, and a thioxanthone photopolymerization initiator. Among them, an acylphosphine oxide photopolymerization initiator is preferred. The use of such a photopolymerization initiator tends to further improve the curability of the ink composition, in particular the curability in a curing process using UV-LED light.

Examples of the acylphosphine oxide photopolymerization initiator include, and are not limited to, 2,4,6-trimethylbenzoyldiphenylphosphine oxide, bis(2,4,6-trimethylbenzoyl)-phenylphosphine oxide, bis-(2,6-dimethoxybenzoyl)-2,4,4-trimethylpentylphosphine oxide, and ethyl phenyl (2,4,6-trimethylbenzoyl)phosphinate.

Examples of commercially available products of such an acylphosphine oxide photopolymerization initiator include IRGACURE 819 (bis(2,4,6-trimethylbenzoyl)-phenylphosphine oxide), IRGACURE 1800 (a mixture of bis-(2,6-dimethoxybenzoyl)-2,4,4-trimethylpentylphosphine oxide and 1-hydroxy-cyclohexyl-phenyl ketone at a mass ratio of 25:75), IRGACURE TPO (2,4,6-trimethylbenzoyldiphenylphosphine oxide), and IRGACURE TPO-L (ethyl phenyl (2,4,6-trimethylbenzoyl)phosphinate), all manufactured by BASF Corporation.

Examples of the thioxanthone photopolymerization initiator include, and are not limited to, thioxanthone, 2-methylthioxanthone, 2,4-diethylthioxanthone, 2-isopropylthioxanthone, 4-isopropylthioxanthone, 2-chlorothioxanthone, and 2,4-diethylthioxanthone.

Examples of commercially available products of the thioxanthone photopolymerization initiator include KAYACURE DETX-S (2,4-diethylthioxanthone, trade name of Nippon Kayaku Co., Ltd.), Speedcure DETX (2,4-diethylthioxanthone, trade name of LAMBSON Ltd.), and KAYACURE ITX (2-/4-isopropylthioxanthone, trade name of Nippon Kayaku Co., Ltd.).

The content of the photopolymerization initiator is preferably 3 to 14 mass %, 5 to 12 mass %, or 7.5 to 10 mass % based on the total amount of the ink composition. When the content of the photopolymerization initiator is within the above ranges, the curability of the composition and the solubility of the photopolymerization initiator tend to be further improved.

### 1.3.3. Polymerization Inhibitor

The ink composition according to the present embodiments may further contain a polymerization inhibitor. The polymerization inhibitor may be of a single type or of a combination of two or more types.

Examples of the polymerization inhibitor include, and are not limited to, p-methoxyphenol, hydroquinone monomethyl ether (MEHQ), 4-hydroxy-2,2,6,6-tetramethylpiperidine-N-oxyl, hydroquinone, cresol, t-butylcatechol, 3,5-di-t-butyl-4-hydroxytoluene, 2,2′-methylenebis(4-methyl-6-t-butylphenol), 2,2′-methylenebis(4-ethyl-6-butylphenol), 4,4′-thiobis(3-methyl-6-t-butylphenol), bis(2,2,6,6-tetramethyl-4-piperidyl-1-oxyl) sebacate (Bis-TEMPO sebacate), and a hindered amine compound.

The content of the polymerization inhibitor is preferably 0.05 to 1 mass %, or 0.05 to 0.5 mass % based on the total amount of the ink composition.

### 1.3.4. Slip Agent

The ink composition according to the present embodiments may further contain a slip agent. The slip agent may be of a single type or of a combination of two or more types.

The slip agent is preferably a silicone surfactant, more preferably a polyester-modified silicone or polyether-modified silicone. Examples of the polyester-modified silicone include BYK-347 and 348, and BYK-UV 3500, 3510, and 3530, all manufactured by BYK Additives & Instruments). An example of the polyether-modified silicone is BYK-3570 manufactured by BYK Additives & Instruments.

The content of the slip agent is preferably 0.01 to 2 mass %, or 0.05 to 1 mass % based on the total amount of the ink composition.

### 1.3.5. Dispersant

The ink composition of the present embodiments may further contain a dispersant to improve the dispersibility of a colorant, etc. The dispersant may be of a single type or of a combination of two or more types.

The dispersant is not particularly limited and may be, for example, a dispersant such as a polymer dispersant commonly used to prepare a pigment dispersion. Specific examples include dispersants comprising, as a main component, one or more of a polyoxyalkylene polyalkylene polyamine, a vinyl polymer or copolymer, an acrylic polymer or copolymer, a polyester, a polyamide, a polyimide, a polyurethane, an amino polymer, a silicon-containing polymer, a sulfur-containing polymer, a fluorine-containing polymer, and an epoxy resin.

Examples of commercially available products of the polymer dispersant include AJISPER series manufactured by Ajinomoto Fine-Techno Co., Inc., SOLSPERSE series (SOLSPERSE 36000, etc.) available from Avecia or Noveon, DISPERBYK series manufactured by BYK Additives & Instruments, and DISPARLON series manufactured by Kusumoto Chemicals Ltd.

The content of the dispersant is preferably 0.1 to 2 mass %, 0.1 to 1 mass %, or 0.1 to 0.5 mass % based on the total amount of the ink composition.

### 1.3.6. Colorant

The ink composition of the present embodiments may further contain a colorant. The colorant may be of a single type or of a combination of two or more types.

The colorant is not particularly limited and may be, for example, a pigment or dye. The colorant may be of a single type or of a combination of two or more types.

The content of the colorant is preferably 0.5 to 15 mass %, more preferably 1.0 to 10 mass %, and even more preferably 2.0 to 7 mass % based on the total amount of the ink composition. When the content of the colorant is within the above ranges, the color development of the ink composition tends to be further improved.

The ink composition of the present embodiments may contain a pigment as the colorant. Examples of the pigment include, and are not limited to, organic pigments such as an azo pigment (e.g., an azo lake, an insoluble azo pigment, a condensed azo pigment, or a chelate azo pigment), a polycyclic pigment (e.g., a phthalocyanine pigment, a perylene pigment, a perinone pigment, an anthraquinone pigment, a quinacridone pigment, a dioxazine pigment, a thioindigo pigment, an isoindolinone pigment, or a quinophthalone pigment), a nitro pigment, a nitroso pigment, and aniline black; inorganic pigments such as carbon black (e.g., furnace black, thermal lamp black, acetylene black, or channel black), a metal oxide, a metal sulfide, and a metal chloride; and extender pigments such as calcium carbonate and talc.

The pigment may be added to the ink composition in the form of a pigment dispersion obtained by dispersing the pigment in water with a dispersant, or a pigment dispersion obtained either by dispersing in water a self-dispersing surface-treated pigment (hereinafter also referred to as “self-dispersing pigment”) in which hydrophilic groups have been introduced to the surfaces of pigment particles through a chemical reaction, or by dispersing in water a pigment coated with a polymer (hereinafter also referred to as “resin-dispersed pigment”). Among them, a self-dispersing pigment is preferably used. The use of a self-dispersing pigment tends to further improve the water repellency of a nozzle plate and the intermittent printing stability.

The pigment and the dispersant, constituting the above-described pigment dispersion, may each be of a single type or of a combination of two or more types.

The ink composition of the present embodiments may contain a dye as the colorant. Examples of the dye include, and are not limited to, acid dyes such as C.I. Acid Yellow, C.I. Acid Red, C.I. Acid Blue, C.I. Acid Orange, C.I. Acid Violet, and C.I. Acid Black; basic dyes such as C.I. Basic Yellow, C.I. Basic Red, C.I. Basic Blue, C.I. Basic Orange, C.I. Basic Violet, and C.I. Basic Black; direct dyes such as C.I. Direct Yellow, C.I. Direct Red, C.I. Direct Blue, C.I. Direct Orange, C.I. Direct Violet, and C.I. Direct Black; reactive dyes such as C.I. Reactive Yellow, C.I. Reactive Red, C.I. Reactive Blue, C.I. Reactive Orange, C.I. Reactive Violet, and C.I. Reactive Black; and disperse dyes such as C.I. Disperse Yellow, C.I. Disperse Red, C.I. Disperse Blue, C.I. Disperse Orange, C.I. Disperse Violet, and C.I. Disperse Black. The dye may be of a single type or of a combination of two or more types.

### 1.4. Recording Medium

The ink composition according to the present embodiments can advantageously be used in an ejection step, which involves ejecting the ink composition onto a recording medium, in an ink jet printing process. The recording medium is not particularly limited and may be, for example, an absorbent or non-absorbent recording medium. A non-absorbent recording medium is preferred.

Examples of the absorbent recording medium include plain paper such as electrophotographic paper, ink jet paper, and art paper, coated paper and cast paper for use in common offset printing.

Examples of the non-absorbent recording medium include a plastic medium made of polyvinyl chloride (PVC), polystyrene (PS), polyethylene terephthalate (PET), polypropylene (PP), polyethylene (PE), polycarbonate, cellulose diacetate, cellulose triacetate, cellulose propionate, cellulose butyrate, cellulose acetate butyrate, cellulose nitrate, polyvinyl acetal, or the like, which may be surface-treated, and media made of glass, metal, or wood.

The form of the recording medium is not particularly limited and may be, for example, a film, a board, or a cloth.

Among these recording media, the ink composition according to the present embodiments is preferably used for a non-absorbent recording medium, especially for a plastic film. In particular, a coating of the ink composition has excellent adhesion to polyethylene terephthalate (PET), polypropylene (PP), polyethylene (PE), polyvinyl chloride (PVC), polystyrene (PS), and polyolefin (PO). Though not being bound to any mechanism, it is considered that the polar resin in the ink composition interacts with the polar interface of such a recording medium, resulting in improved adhesion between the ink composition and the recording medium. Polyethylene terephthalate (PET), polypropylene (PP), and polyethylene (PE) are more preferred. When a shrink film, which shrinks e.g. on application of heat thereto, is used as a recording medium, the ink composition exhibits excellent adhesion and the recording medium has enhanced processability.

A non-absorbent or low-absorbent recording medium can be determined by the wettability of its recording surface by water. For example, a 0.5 μL water drop is dropped onto the recording surface of a recording medium, and the rate of decrease in the contact angle (comparison of the contact angle 0.5 milliseconds after contact with the contact angle 5 seconds after contact) can be used to characterize the recording medium. More specifically, a non-absorbent recording medium, a low-absorbent recording medium, and an absorbent recording medium refer to a recording medium in which the rate of decrease in the contact angle is less than 1%, a recording medium in which the rate of decrease is not less than 1% and less than 5%, and a recording medium in which the rate of decrease is 5% or more, respectively. The contact angle can be measured using a portable contact angle meter, for example PCA-1 (manufactured by Kyowa Interface Science Co., Ltd.).

### 1.5. Method for Producing Ink Composition

The ink composition is produced (prepared) by stirring the components of the ink composition such that they are mixed sufficiently uniformly. In the present embodiments, the ink composition preparation process preferably includes a step of subjecting a mixture of a photopolymerization initiator and at least part of the monomer to at least one of an ultrasonic treatment and a heat treatment. This makes it possible to reduce the amount of dissolved oxygen in the prepared ink composition, thus obtaining an ink composition having excellent ejection stability and storage stability. The mixture may contain at least the above components, and may be one that further contains other component(s) of the ink composition, or one that contains all the components of the ink composition. The monomer contained in the mixture may be at least part of the entire monomer to be contained in the ink composition.

### 2. Ink Jet Print Recording Method

The ink jet print recording method according to the present embodiments includes an ejection step of ejecting the ink composition according to the present embodiments and attaching it to a recording medium using a predetermined ink jet head, and a curing step of applying radiation to the ink composition on the recording medium to cure the ink composition.

### 2.1. Corona Treatment Step

The ink jet print recording method according to the present embodiments may further include a corona treatment step in addition to the above steps. In the corona treatment step, a corona treatment is performed on that surface of the recording medium to which the ink composition is to be attached in the subsequent ejection step. The corona treatment improves the adhesion between the recording medium and the ink composition in the ejection step. Conditions for the corona treatment are not particularly limited, and may be set appropriately depending on the type of the recording medium, etc.

For example, when a plastic film is used as the recording medium, the adhesion between the recording medium and the ink composition is sometimes insufficient. The adhesion of the recording medium to the ink composition can be improved by subjecting the recording medium to the corona treatment as a pre-ejection step to modify the surface of the recording medium.

### 2.2. Ejection Step

In the ejection step, the ink composition, which has been heated, is ejected from a liquid ejection head and attached to the recording medium. More specifically, a pressure generating means is driven to eject the ink composition, which has been filled into a pressure generating chamber of the liquid ejection head, from a nozzle. Such an ejection method is also called an ink jet method. Ejection conditions in the ejection step may be adjusted appropriately depending on the physical properties of the ink composition.

The recording medium is not particularly limited and may be the above-described one. A non-absorbent recording medium is preferred, and a plastic film is more preferred for the ink composition according to the present embodiments.

### 2.3. Curing Step

In the curing step, radiation is applied to the ink composition on the recording medium. When radiation is applied, a polymerization reaction of the monomer starts and the composition is cured to form a coating. If a photopolymerization initiator is present, it generates an active species (initiation species) such as a radical, an acid or a base. The polymerization reaction of the monomer is promoted by the function of the initiation species. If a photosensitizer is present, it absorbs radiation and becomes excited. The excited photosensitizer, upon contact with the photopolymerization initiator, promotes the decomposition of the photopolymerization initiator, thus achieving a more sufficient curing reaction.

Examples of the radiation include ultraviolet light, infrared light, visible light, and X-rays. The radiation is emitted toward the composition by a radiation source provided downstream of the liquid ejection head. The radiation source is not particularly limited and may be, for example, a UV light-emitting diode. The use of such a radiation source can achieve a reduction in the size and cost of the apparatus used. A UV light-emitting diode as a UV light source is small-sized, and therefore can be installed within an ink jet apparatus.

For example, the UV light-emitting diode can be mounted to a carriage (at its both ends in the medium width direction and/or on the medium transport direction side) on which the liquid ejection head for ejecting the ink composition is mounted. Owing to the above-described composition of the ink composition, low-energy and high-speed curing can be achieved. The irradiation energy is calculated by multiplying the irradiation time by the irradiation intensity. Therefore, the irradiation time can be reduced and the printing speed can be increased. On the other hand, the irradiation intensity can be reduced. This can reduce the rise in the temperature of a print, leading to a reduction in the odor of a cured coating.

The thickness of a coating of the ink composition, which has been cured in the curing step, is not particularly limited; however, it is preferably 10 μm or less, and particularly preferably 5 μm or less.

### 2.4. Winding Step

The ink jet print recording method according to the present embodiments may further include a winding step in addition to the above-described steps. In the winding step, a recorded product, composed of the cured ink composition on the recording medium, is wound up by a winding device. The winding device is not particularly limited and may be a known device such as a roller.

### EXAMPLES

The present disclosure will be described in further detail using the following examples. It is to be noted that the present disclosure is not limited to the examples in any way.

### 1. Preparation of Ink Composition

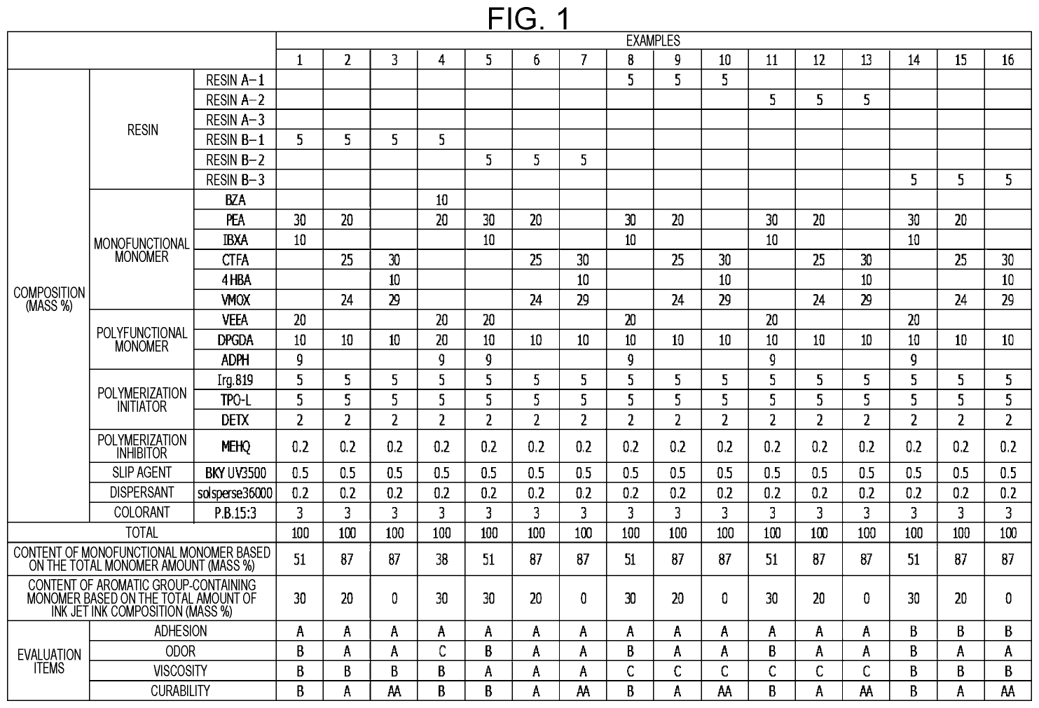

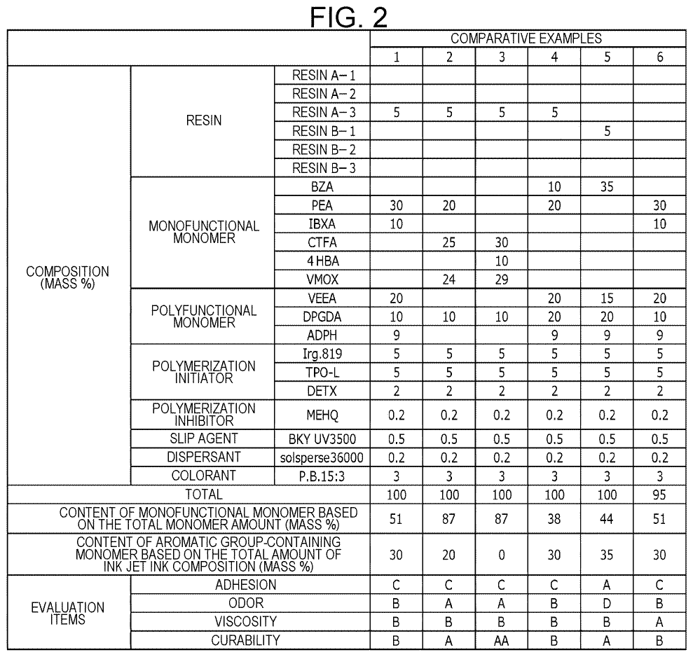

First, a colorant, a dispersant, and part of a monomer(s) were weighed and placed in a pigment dispersion tank, and a ceramic bead mill with a diameter of 1 mm was placed in the tank, and the mixture was stirred to obtain a pigment dispersion in which the colorant was dispersed in the monomer(s). Next, the remaining monomer(s), a resin, a photopolymerization initiator, a polymerization inhibitor, and a slip agent were placed, in such amounts as to make a composition as shown in FIG. 1 or 2, into a mixing tank which was a stainless steel container, and mixed and stirred to completely dissolve the mixture. Thereafter, the above pigment dispersion was placed into the mixing tank, and the resulting mixture was further mixed and stirred at room temperature for 1 hour, followed by filtration through a 5-μm membrane filter to obtain an ink composition of each Example. The numerical values for the components of Examples, shown in Tables 1 and 2, are mass % unless otherwise specified.

The abbreviations and the components of the products, used in FIGS. 1 and 2, are as follows.

### Resins

Resin A-1 (trade name “UC-3000”, manufactured by Toagosei Co., Ltd., glass transition temperature: 65° C., weight average molecular weight: 10000)
Resin A-2 (trade name “UH-2000”, manufactured by Toagosei Co., Ltd., glass transition temperature: −55° C., weight average molecular weight: 11000)
Resin A-3 (trade name “UP-1000”, manufactured by Toagosei Co., Ltd., glass transition temperature: −77° C., weight average molecular weight: 3000)
Resin B-1 (trade name “Variplus SK”, manufactured by EVONIK, glass transition temperature: 90° C., hydroxyl value: 325 mgKOH/g)
Resin B-2 (trade name “Variplus AP”, manufactured by EVONIK, glass transition temperature: 50° C., hydroxyl value: 5 mgKOH/g)
Resin B-3 (trade name “Variplus CA”, manufactured by EVONIK, glass transition temperature: 70° C., hydroxyl value: 110 mgKOH/g) Monomers
BZA (trade name “Viscoat #160”, manufactured by Osaka Organic Chemical Industry Ltd., benzyl acrylate)
PEA (trade name “Viscoat #192”, manufactured by Osaka Organic Chemical Industry Ltd., phenoxyethyl acrylate)
IBXA (manufactured by Osaka Organic Chemical Industry Ltd., isobornyl acrylate)
CTFA (trade name “Viscoat #200”, manufactured by Osaka Organic Chemical Industry Ltd., cyclic trimethylolpropane formal acrylate)
4HBA (manufactured by Mitsubishi Chemical Corporation, 4-hydroxybutyl acrylate)
VMOX (manufactured by BASF Corporation, vinylmethyloxazolidinone)
VEEA (manufactured by Nippon Shokubai Co., Ltd., 2-(2-vinyloxyethoxy)ethyl acrylate)
DPGDA (trade name “SR508”, manufactured by Sartomer Company, dipropylene glycol diacrylate)
ADPH (manufactured by Shin-Nakamura Chemical Co., Ltd., pentaerythritol hexaacrylate) Photopolymerization Initiators
Irg. 819 (trade name “IRGACURE 819”, manufactured by BASF Corporation, bis(2,4,6-trimethylbenzoyl)-phenylphosphine oxide)
TPO-L (trade name “IRGACURE TPO-L”, manufactured by BASF Corporation, ethyl phenyl (2,4,6-trimethylbenzoyl)phosphinate)
DETX (trade name “Speedcure DETX”, manufactured by Lambson Ltd., 2,4-diethylthioxanthen-9-one) Polymerization Inhibitor
MEHQ (trade name “p-methoxyphenol”, manufactured by Kanto Chemical Co., Inc., hydroquinone monomethyl ether) Slip Agent
BYK-UV3500 (manufactured by BYK Additives & Instruments, acryloyl group-containing polyether-modified polydimethylsiloxane)

### Dispersant

Solsperse 36000 (manufactured by Lubrizol Corporation, polymer dispersant) Colorant
PB-15:3 (Pigment Blue 15:3)

### 2. Evaluation Methods

### 2.1. Evaluation of Curability

Each of the ink compositions of Examples and Comparative Examples was applied to a substrate in such an amount as to form a coating having a thickness of 8 μm (thickness after curing), and the curing energy required for curing was determined. The coating was rubbed with a cotton swab and the state of the cotton swab was checked to determine whether the coating was cured. Ultraviolet irradiation of the coating was performed using an LED having a peak wavelength of 395 nm and an irradiation intensity of 1100 mW/cm². The substrate was a PET film (PET50A PL Thin [trade name], manufactured by Lintec Corporation). The irradiated coating (composition coating) was rubbed 10 times with a cotton swab under a load of 100 g, and the curing energy (irradiation energy) was determined at the point in time when no scratches were formed anymore. The curability of the coating was evaluated according to the following evaluation criteria.

The irradiation energy [mJ/cm²] was determined by measuring the irradiation intensity [mW/cm²] at a coating surface being irradiated with ultraviolet light from the light source, and calculating the product of the measured value and the duration [s] of irradiation. The measurement of the irradiation intensity was performed using a UV intensity meter UM-10 and a light receiving unit UM-400, both manufactured by Konica Minolta Sensing, Inc.

### Evaluation Criteria

AA: Irradiation energy is 200 mJ/cm² or less.
A: Irradiation energy is more than 200 mJ/cm² and not more than 300 mJ/cm2.
B: Irradiation energy is more than 300 mJ/cm² and not more than 400 mJ/cm².
C: Irradiation energy is more than 400 mJ/cm².

### 2.2. Evaluation of Adhesion

Each of the ink compositions of Examples and Comparative Examples was applied to a PET film (PET50A PL Thin [trade name], manufactured by Lintec Corporation) in such an amount as to form a coating having a thickness of 8 μm (thickness after curing), and was irradiated with radiation (UV light) under the same conditions as in the evaluation of curability until no scratches were formed in the coating. Each of the ink compositions of Examples and Comparative Examples was thus cured to produce a recorded product. The recorded product was evaluated by a cross-cut method in accordance with JIS K 5600-5-6.

More specifically, a cutter blade was applied to a cured coating at a right angle, and the coating was cut to form a grid of 10×10 squares with a line-to-line spacing of 1 mm. A transparent adhesive tape (25 mm wide) having a length of about 75 mm was attached to the grid, and the tape was rubbed thoroughly with a finger so that the cured coating would be visible through it. Next, within 5 minutes after attaching the tape to the grid, the tape was securely peeled off the cured coating at an angle of around 60° in 0.5 to 1.0 seconds, and the state of the grid was visually observed. The evaluation criteria are as follows. The rating A (exceptional) and the rating B (excellent) were evaluated as acceptable, while the rating C (poor) was evaluated as unacceptable.
A: No peeling of the cured coating was observed.
B: Peeling of the cured coating was observed in 50% or less of the grid.
C: Peeling of the cured coating was observed in more than 50% of the grid.

### 2.3. Evaluation of Odor

The odor of each of the prepared ink compositions was smelled and evaluated. In order to reduce individual differences in the sense of smell, 10 people tested the same sample and scored the odor as follows. The average score of the 10 people was calculated, and the odor was rated at four levels, A to D, based on the average score. The rating A (exceptional), the rating B (excellent), and the rating C (good) were evaluated as acceptable, while the rating D (poor) was evaluated as unacceptable.
0 points: no odor or barely noticeable odor
1 point: slight odor
2 points: easily noticeable odor
3 points: strong odor
A: The average score is not less than 0 points and less than 0.5 points.
B: The average score is not less than 0.5 points and less than 1.5 points.
C: The average score is not less than 1.5 points and less than 2.5 points.
D: The average score is not less than 2.5 points and less than 3.0 points.

### 2.4. Evaluation of Viscosity

The viscosity of each ink composition immediately after its preparation was measured based on JIS Z 8803 in an environment at 25° C. using a rotational viscometer (product name “Rheometer MCR-301”, manufactured by Anton Paar). The evaluation criteria are as follows:
A: The viscosity is less than 20 mPa·s.
B: The viscosity is not less than 20 mPa·s and less than 40 mPa·s.
C: The viscosity is not less than 40 mPa·s.

### 3. Evaluation Results

FIGS. 1 and 2 show the chemical compositions of the ink compositions of the examples as well as the evaluation results. As can be seen in FIG. 1, the ink compositions of Examples 1 to 16, which each contain no aromatic group-containing monomer, or contain an aromatic group-containing monomer in an amount of less than 35 mass % based on the total amount of the ink composition, and contain at least one of an acrylic resin (A) having hydroxy groups or carboxy groups and a resin (B) having one or more structural units selected from the group consisting of the predetermined structural units, have a good level of adhesion and odor.

In particular, comparison of data between the Examples and Comparative Examples 1-4 and 6 indicates that compared to the ink compositions of Comparative Examples 1-4, which use the resin that does not have a polar group such as a hydroxy group, a carboxy group, or a ketone group, and the ink composition of Comparative Example 6 which uses no resin, the ink compositions of the Examples have an improved adhesion.

Further, comparison of data between the Examples and Comparative Example 5 indicates that compared to the ink composition of Comparative Example 5, in which the content of the aromatic group-containing monomer is 35 mass % or more based on the total amount of the ink composition, the ink compositions of the Examples have a reduced odor.

What is claimed is:

1. An ink jet ink composition comprising a monomer and a resin, wherein the monomer does not comprise an aromatic group-containing monomer, or comprises an aromatic group-containing monomer in an amount of less than 35 mass % based on the total amount of the ink jet ink composition, and wherein the resin comprises at least one of an acrylic resin (A) having hydroxy groups or carboxy groups and a resin (B) having one or more structural units selected from the group consisting of structural units represented by the following formulas (1), (2), and (3):

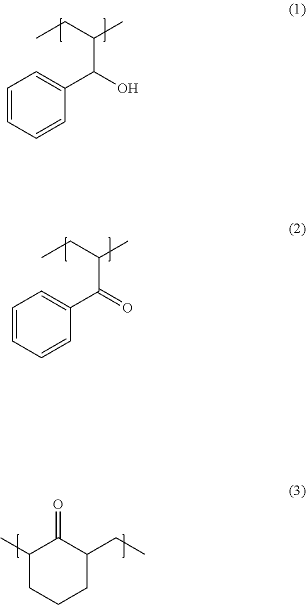

2. The ink jet ink composition according to claim 1, wherein the weight average molecular weight of the resin is 5000 or less.

3. The ink jet ink composition according to claim 1, wherein the content of the resin is 10 mass % or less based on the total amount of the ink jet ink composition.

4. The ink jet ink composition according to claim 1, wherein the monomer comprises vinylmethyloxazolidinone.

5. The ink jet ink composition according to claim 1, wherein the monomer comprises a monofunctional monomer, and the content of the monofunctional monomer is 40 to 90 mass % based on the total monomer amount.

6. The ink jet ink composition according to claim 1, wherein the monomer comprises a hydroxy group-containing monomer.

7. The ink jet ink composition according to claim 1, wherein the monomer comprises a vinyl ether group-containing (meth)acrylate represented by the following formula (4):
CH₂═CR¹—COOR²—O—CH═CH—R³ (4)
where R¹ is a hydrogen atom or a methyl group, R² is a divalent organic residue having 2 to 20 carbon atoms, and R³ is a hydrogen atom or a monovalent organic residue having 1 to 11 carbon atoms.

8. The ink jet ink composition according to claim 1, wherein the content of the aromatic group-containing monomer is 20 mass % or less based on the total amount of the ink jet ink composition.

9. The ink jet ink composition according to claim 1 for printing on a non-absorbent recording medium.

10. An ink jet print recording method comprising:
an ejection step of ejecting the ink jet ink composition according to claim 1 from an ink jet head and attaching the composition to a non-absorbent recording medium; and
a curing step of curing the ink jet ink composition on the non-absorbent recording medium.

11. The recording method according to claim 10, further comprising a winding step of winding up the non-absorbent recording medium having the ink jet ink composition after curing on it, wherein in the curing step, the thickness of a coating of a cured product of the ink jet ink composition is 10 μm or less.

12. The recording method according to claim 10, further comprising a corona treatment step of performing, prior to the ejection step, a corona treatment on that surface of the non-absorbent recording medium to which the ink jet ink composition is to be attached.
